(19) United States
(12) Patent Application Publication
(10) Pub. No.: US 2026/0084931 A1
(43) Pub. Date: Mar. 26, 2026

(54) BRAKE DEVICE AND BRAKE SYSTEM FOR AN ELEVATOR, ELEVATOR AND METHOD OF OPERATING AN ELEVATOR

(71) Applicant: KONE CORPORATION, Helsinki (FI)

(72) Inventors: Marko Minkkinen, Helsinki (FI); Tuukka Korhonen, Helsinki (FI); Ville Myyryläinen, Helsinki (FI); Jorma Mustalahti, Helsinki (FI)

(73) Assignee: KONE CORPORATION, Helsinki (FI)

(21) Appl. No.: 19/407,362

(22) Filed: Dec. 3, 2025

Related U.S. Application Data
(63) Continuation of application No. PCT/FI2023/050337, filed on Jun. 9, 2023.

(51) Int. Cl. B66B 5/20; B66B 5/22

(52) U.S. Cl. CPC B66B 5/20; B66B 5/22

(57) ABSTRACT

The brake device for an elevator includes a frame configured to be rigidly attached to an elevator car or to a stationary body part of a hoisting machinery, a brake caliper slidably mounted to the frame, a brake element mounted to the brake caliper, brake actuator and brake release for moving the brake element between a braking position and a retracted position, a fluid chamber, and a piston having a first piston surface delimiting the fluid chamber. One of the fluid chamber and the piston is configured to move with the brake caliper and the other is configured to move with the frame such that a brake force applied to the guide rail or to the brake disc by the brake device strives to move the piston and the fluid chamber relative to each other.

### TECHNICAL FIELD OF THE INVENTION

The present invention concerns a brake device for an elevator car or a hoisting machinery of an elevator, as defined in claim 1. The invention also concerns a brake system for an elevator, an elevator, and a method of operating an elevator.

### BACKGROUND OF THE INVENTION

Elevator hoisting machinery may have safety brakes, which may have a frame part, a moving armature and a thrust spring in between. A brake pad is attached to the moving armature. The thrust spring causes the brake pad to engage against a traction sheave or a rotating shaft of the hoisting machinery. This engagement causes a braking torque to stop movement of the hoisting machinery and therefore an elevator car. The brakes may be used in emergency braking to stop the elevator car if an operational anomaly occurs, such as an overspeed situation of the car.

An elevator may have hoisting ropes running between an elevator car and a counterweight, via the traction sheave of the hoisting machinery.

Recently new kind of coated hoisting ropes have been introduced. These may be round ropes with a high-friction coating, or belts with high-friction coating, such as a polyurethane coating. Load-carrying parts of the round ropes or belts may be steel cords or they can be made of synthetic fibers, such as glass fibers or carbon fibers, for example.

These new kind of coated hoisting ropes cause a higher friction between the ropes and the traction sheave than traditional steel ropes. Reduction in slipping of the ropes on the traction sheave may lead to excessive deceleration of an elevator car in an emergency stopping situation, which is a non-desired condition for the elevator passengers.

An elevator car may be provided with safety brakes engaging against the nose of an elevator guide rail in an operational anomaly, such as is an emergency stopping situation of an elevator car. In specific operational situations of the car, such as if the safety brakes are engaged, when a car with nominal load is moving upwards or an empty car is moving downwards, uncontrolled braking force of the safety brakes may lead to excessive deceleration, which is non-desired for the passengers.

In some other recent elevator systems, lifting height and thus the travel length of the elevator car has been increased. This is the case for example in so called high-rise and ultra-high-rise elevators. In those elevator systems longer hoisting ropes may cause a bouncing effect of the car when the safety brakes of the car are opened at the beginning of a new elevator run.

There are thus various situations where a more precise control of the brakes of an elevator would be useful.

### SUMMARY OF THE INVENTION

An object of the present invention is to provide an improved brake device for an elevator car or a hoisting machinery of an elevator. The brake device is configured to cooperate with a guide rail of the elevator or with a brake disc of the hoisting machinery for applying a brake force to the guide rail or brake disc when actuated. Other objects of the invention are to provide an improved brake system for an elevator and an improved elevator. A still further object of the invention is to provide an improved method of operating an elevator.

The brake device according to the invention comprises a frame that is configured to be rigidly attached to the elevator car or to a stationary body part of the hoisting machinery, a brake caliper slidably mounted to the frame, at least one brake element that is mounted to the brake caliper and moveable between a braking position and a retracted position, brake actuation means and brake release means for moving said at least one brake element between the braking position and the retracted position, a fluid chamber, and a piston having a first piston surface delimiting said fluid chamber. One of the fluid chamber and the piston is configured to move with the brake caliper and the other is configured to move with the frame such that a brake force applied to the guide rail or to the brake disc by means of the brake device strives to move the piston and the fluid chamber relative to each other.

The brake device according to the invention allows measuring and monitoring of the brake force applied to the guide rail or to the brake disc by the brake device. This allows more precise control of the brake force.

According to an embodiment of the invention, the brake device comprises means for monitoring the pressure in the fluid chamber. By monitoring the pressure in the fluid chamber, the brake force can be determined. The means for monitoring the pressure could also be arranged apart from the brake device.

According to an embodiment of the invention, the brake device comprises a second fluid chamber and a piston having a second piston surface delimiting the second fluid chamber, the first piston surface and the second piston surface facing opposite directions, wherein one of the second fluid chamber and the piston having the second piston surface is configured to move with the brake caliper and the other is configured to move with the frame such that a brake force applied to the guide rail or to the brake disc by means of the brake device strives to move the piston and the second fluid chamber relative to each other. The two fluid chambers and pistons allow determining the brake force in two moving directions of the elevator.

According to an embodiment of the invention, the brake device comprises means for monitoring the pressure in the second fluid chamber. By monitoring the pressure, the brake force can be determined.

According to an embodiment of the invention, the brake device is configured to allow supply of pressurized hydraulic fluid into the fluid chambers and discharge of hydraulic fluid from the fluid chambers to move the frame relative to the brake caliper. By moving the frame in relation to the brake caliper, the position of the elevator car can be adjusted. This could be utilized, for instance, for releasing an activated safety gear of the elevator.

According to an embodiment of the invention, the brake actuation means comprise at least one biasing spring that is configured to bias said at least one brake element towards the braking position and the brake release means comprise at least one cylinder and a piston moveable within the cylinder, the brake release means being configured to move said at least one brake element to the release position when hydraulic pressure overcoming a biasing force caused by said at least one biasing spring is applied to the piston of the brake release means. Hydraulically releasable brakes enable precise control of the brake force with minimal energy consumption.

The brake system according to the invention comprises at least one brake device defined above and means for monitoring the pressure in the fluid chamber.

According to an embodiment of the invention, the brake system comprises means for supplying pressurized hydraulic fluid into the fluid chamber. By supplying pressurized hydraulic fluid into the fluid chamber, the position of the brake caliper relative to the frame can be adjusted. This allows moving the elevator car in the vertical direction, for instance for releasing an activated safety gear.

According to an embodiment of the invention, the brake system is configured to control the brake force applied to the guide rail or to the brake disc based on the pressure in the fluid chamber. This allows controlled deceleration of the elevator.

According to an embodiment of the invention, the brake device comprises brake release means having at least one cylinder and a piston moveable within the cylinder, and the brake system comprises pressurizing means configured to pressurize hydraulic fluid and being arranged in fluid communication with said at least one cylinder of the brake release means to allow supplying pressurized hydraulic fluid into said at least one cylinder.

According to an embodiment of the invention, the pressurizing means comprise a hydraulic cylinder and a piston that are configured to be moveable relative to each other to pressurize hydraulic fluid in the hydraulic cylinder, the hydraulic cylinder being arranged in fluid communication with said at least one cylinder of the brake release means to allow supplying pressurized hydraulic fluid into said at least one cylinder. The hydraulic cylinder and piston allow precise control of the pressure.

The elevator according to the invention comprises an elevator car, a hoisting machinery and a brake system defined above, wherein said at least one brake device is mounted to the elevator car or to the hoisting machinery.

The method of operating an elevator defined above comprises the step of measuring the pressure in the fluid chamber.

According to an embodiment of the invention, the method comprises the step of determining, based on the measured pressure, the brake force applied by the brake device to the guide rail or to the brake disc.

According to an embodiment of the invention, the method comprises the step of determining, based on the measured pressure, the weight of the elevator car. By determining the weight of the car, the brake force and releasing of the brakes can be adjusted to provide smooth acceleration and deceleration.

According to an embodiment of the invention, the method comprises the step of controlling, based on the measured pressure, the brake force applied to the guide rail or to the brake disc by the brake device.

According to an embodiment of the invention, the method comprises the steps of applying a brake force to the guide rail or to the brake disc by means of the brake device, determining the brake force based on the pressure in the fluid chamber, comparing the determined brake force to a reference value, and adjusting the brake force based on the comparison.

According to an embodiment of the invention, the brake device is mounted to the elevator car and the method comprises the steps of applying a brake force to the guide rail by means of the brake device to keep the brake caliper stationary relative to the guide rail, and supplying pressurized hydraulic fluid into the fluid chamber to move the elevator car relative to the brake caliper. This allows releasing of an activated safety gear.

According to an embodiment of the invention, the brake device is mounted to the elevator car and the method comprises the steps of moving the elevator car along the guide rail, applying a brake force to the guide rail by means of the brake device, monitoring the pressure in the fluid chamber, adjusting the brake force based on the pressure in the fluid chamber until a predetermined brake force is reached, maintaining said predetermined brake force, and keeping the elevator car moving along the guide rail to clean said at least one brake element of the brake device and/or the guide rail. The brakes and the guide rail can thus be cleaned with a minimum brake force.

### BRIEF DESCRIPTION OF THE DRAWINGS

Embodiments of the invention are described below in more detail with reference to the accompanying drawings, in which

FIG. 1 shows schematically some features of a brake device and a brake system according to an embodiment of the invention,

FIG. 2 shows schematically other features of a brake device and a brake system according to an embodiment of the invention,

FIG. 3 shows schematically parts of an elevator, and

FIG. 4 shows schematically an example of a hoisting machinery of an elevator.

### DETAILED DESCRIPTION OF EMBODIMENTS OF THE INVENTION

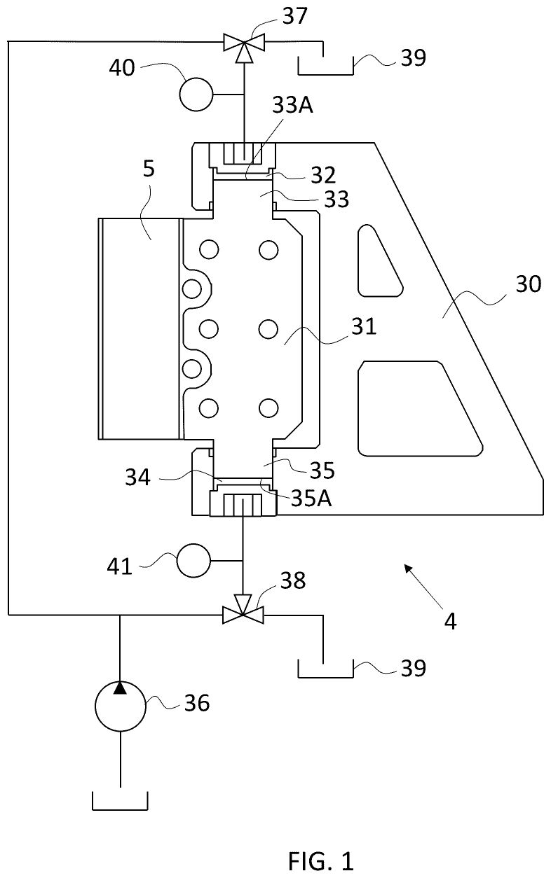

FIG. 1 shows schematically a brake device 4 and a brake system according to an embodiment of the invention. The brake device 4 according to the invention is used as a brake of an elevator car 3 or a hoisting machinery 19 of an elevator. If the brake device 4 is used in an elevator car 3, it is configured to cooperate with a guide rail 2 of the elevator car 3. If the brake device 4 is used as a brake of a hoisting machinery 19, it is configured to cooperate with a brake disc 20 of the hoisting machinery 19. When the brake device 4 is actuated, it applies a brake force to the guide rail 2 or brake disc 20.

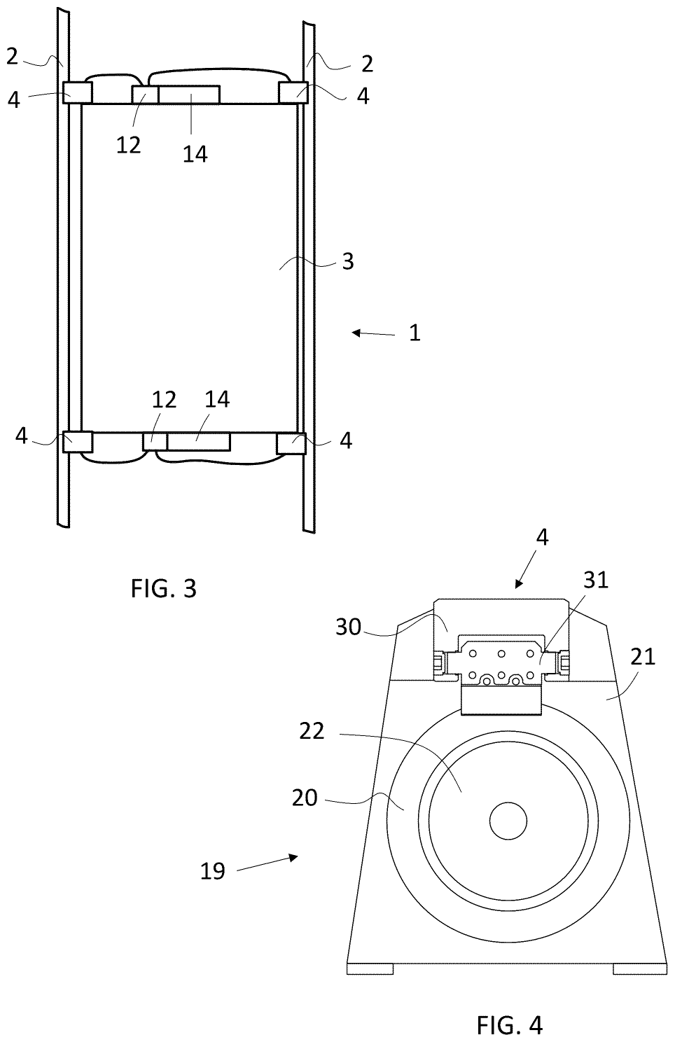

An elevator, where the brake device 4 can be used, comprises an elevator car 3 that is arranged into an elevator shaft. FIG. 3 shows schematically an elevator car 3. The elevator car 3 can move in the elevator shaft in the vertical direction. The elevator 1 further comprises a counterweight (not shown). The elevator car 3 is connected to the counterweight via a hoisting member. The hoisting member can be, for example, a steel wire, a belt, such as a toothed belt or a flat belt, a carbon fiber rope or a coated rope. The elevator can comprise several hoisting members. The elevator car 3 and the counterweight are connected to each other in such a way that they move to opposite directions in respect of each other. The elevator 1 is further provided with a hoisting machinery 19. An example of a hoisting machinery 19 is schematically shown in FIG. 4. The hoisting machinery 19 can comprise an electric motor. The motor drives a sheave 22, which can be connected to the motor either directly or via a gear. As the sheave 22 rotates, the hoisting member moves and the elevator car 3 and the counterweight are moved. The motor can be arranged in a machine room located above the elevator shaft. Alternatively, the elevator can be a machine-room-less elevator and the motor can be arranged in the elevator shaft.

The elevator car 3 is guided in the elevator shaft by guide rails 2. A pair of guide rails 2 is arranged on opposite sides of the elevator shaft. The guide rail 2 can be, for instance, a T-shaped profile. The arms of the profile are attached to the walls of the elevator shaft, for instance via guide rail brackets. The stem, or nose, of the profile forms two guide surfaces for guiding the elevator car 3. The elevator car 3 can be provided with rollers or other elements that roll or slide against the guide surfaces of the guide rail 2.

The elevator is provided with one or more brake systems for stopping the elevator and/or for preventing the elevator from moving. The brake systems can be configured to brake the hoisting machinery 19, the elevator car 3 or the counterweight. Different brake systems can provide redundancy and/or they can have different functions. Even a single brake system can have different functions. For instance, a brake system can function during the normal operation of the elevator for stopping the elevator or keeping the elevator car 3 in a correct position at a landing, but also as an emergency brake for stopping the elevator in an overspeed situation.

In addition to various brake systems, the elevator can comprise a safety gear that is configured to stop the elevator car 3 in case of an emergency, such as in an overspeed situation of the elevator car 3. The safety gear comprises a wedge mechanism that is moveable into a gripping position against a guide rail 2 of the elevator car 3 when the safety gear is actuated.

The safety gear can be activated by a mechanical overspeed governor, which has a governor rope coupled to the safety gear and running via a governor sheave. The elevator car 3 can have two such safety gears disposed on the opposite sides of the elevator car 3 and interconnected by a common synchronization axis, which ensures that both safety gears will be activated upon operation of the overspeed governor. Alternatively, the safety gear can be electrically or hydraulically actuated.

The brake device 4 according to the invention comprises a frame 30 that is configured to be rigidly attached to the elevator car 3 or to a stationary body part 21 of the hoisting machinery 19. The brake device 4 further comprises a brake caliper 31 slidably mounted to the frame 30. In a brake device 4 mounted to an elevator car 3, the brake caliper 31 is slidable in a direction that is parallel to the longitudinal direction of the guide rail 2 of the elevator car 3. In a brake device 4 mounted to a hoisting machinery 19, the brake caliper 31 is slidable in a tangential direction of a brake disc 20 of the hoisting machinery 19. The brake device 4 further comprises at least one brake element 5 that is mounted to the brake caliper 30 and moveable between a braking position and a retracted position, and brake actuation means 6 and brake release means 7 for moving the brake element 5 between the braking position and the retracted position. In the braking position, the brake element 5 is configured to apply a friction force to the guide rail 2 or the brake disc 20.

The brake device 4 further comprises a first fluid chamber 32 and a first piston 33 having a first piston surface 33A delimiting the first fluid chamber 32. In the embodiments of the figures, the first fluid chamber 32 is arranged in the frame 30 and thus moves with the brake caliper 31. The first piston 33 is configured to move with the brake caliper 31. A brake force applied to the guide rail 2 or to the brake disc 20 by means of the brake device 4 strives to move the first piston 33 relative to the first fluid chamber 32.

Instead of the configuration of FIG. 1, the first piston 33 could be configured to move with the frame 30 and the first fluid chamber 32 could be part of the brake caliper 31.

In the embodiment of FIG. 1, the brake device 4 comprises a second fluid chamber 34 and a second piston 35 having a second piston surface 35A delimiting the second fluid chamber 35. The first piston surface 33A and the second piston surface 35A face opposite directions. The second piston 35 is configured to move with the brake caliper 31 and the second fluid chamber 34 is configured to move with the frame 30. A brake force applied to the guide rail 2 or to the brake disc 20 by means of the brake device 4 strives to move the second piston 35 relative to the second fluid chamber 34. Instead of the configuration of FIG. 1, the second piston 35 could be configured to move with the frame 30 and the second fluid chamber 34 could be part of the brake caliper 31.

In a brake device 4 that is mounted to an elevator car 3, each of the first piston 33 and the second piston 35 protrudes into the respective fluid chamber 32, 34 in a direction that is parallel to the longitudinal direction of the guide rail 2. In a brake device 4 that is mounted to a hoisting machinery 19, each of the first piston 33 and the second piston 35 protrudes into the respective fluid chamber 32, 34 in a direction that is parallel to the tangential direction of the brake disc 20.

In the embodiment of FIG. 1, the brake caliper 31 is slidably supported to the frame 30 by the first piston 33 protruding into the first fluid chamber 32 and the second piston 35 protruding into the second fluid chamber 34. However, the brake device 4 could comprise additional means for slidably supporting the brake caliper 31 to the frame 30. The first piston surface 33A and the second piston surface 35A could be opposite ends of a single piston.

As the elevator car 3 moves downwards and a brake force is applied to the guide rail 2 by the brake device 4, the brake force resists the movement of the brake caliper 31 and the brake caliper 31 moves relative to the frame 30 of the brake device 4 in a direction that is parallel to the longitudinal direction of the guide rail 2. As a consequence, fluid in the first fluid chamber 32 is compressed and the pressure in the first fluid chamber 32 increases. By measuring the pressure in the first fluid chamber 32, the brake force can be determined. Similarly, as the elevator car 3 moves upwards and a brake force is applied to the guide rail 2 by the brake device 4, the brake force resists the movement of the brake caliper 31 and the brake caliper 31 moves relative to the frame 30 of the brake device 4. As a consequence, fluid in the second fluid chamber 34 is compressed and the pressure in the second fluid chamber 34 increases. By measuring the pressure in the second fluid chamber 34, the brake force can be determined. A brake device 4 mounted to a hoisting machinery 19 functions in a similar manner.

As the pressure in the first fluid chamber 32 increases, underpressure is formed in the second fluid chamber 34. In principle, the brake force could be calculated from the underpressure. However, if the fluid chambers 32, 34 are filled with hydraulic fluid having low compressibility, the movements of the brake caliper 31 relative to the frame 30 are small, and determining the brake force from the increased pressure gives more accurate results. If there is a need to determine the brake force only in one moving direction of the elevator, one of the fluid chambers 32, 34 and pistons 33, 35 could be replaced, for instance, by sufficiently stiff springs. The brake device 4 could thus comprise a single fluid chamber and a single piston.

The fluid chambers 32, 34 can be closed volumes filled with suitable hydraulic fluid. Alternatively, the brake device 4 can be configured to allow supply of pressurized hydraulic fluid into the fluid chambers 32, 34 and discharge of hydraulic fluid from the fluid chambers 32, 34 to move the frame 30 relative to the brake caliper 31. By applying a sufficient brake force to the guide rail 2 to keep the brake caliper 31 stationary in relation to the guide rail 2, the elevator car 3 can be moved in the vertical direction by supplying pressurized hydraulic fluid into one of the fluid chambers 32, 34. This function can be utilized, for instance, after a safety gear of the elevator has been activated and the wedge mechanism of the safety gear is in a gripping position against the guide rail 2. By moving the elevator car 3, the wedge mechanism can be released.

The brake system according to the invention can comprise one or more brake devices 4 according to the invention and means 40, 41 for monitoring the pressure in the first fluid chamber 32 and the second fluid chamber 34. The means for monitoring the pressure can comprise one or more pressure sensors 40, 41. The pressure sensors can be integrated to the brake device 4. Alternatively, the pressure sensors can be arranged at a distance from the brake device 4 and configured to measure the pressure in a fluid line supplying hydraulic fluid to the fluid chambers 32, 34 of the brake device 4. In the embodiment of FIG. 1, the brake system comprises a first pressure sensor 40 that is arranged to monitor the pressure in the first fluid chamber 32, and a second pressure sensor 41 that is arranged to monitor the pressure in the second fluid chamber 34.

In the embodiment of FIG. 1, the brake system comprises means for supplying pressurized hydraulic fluid into the first and second fluid chamber 32, 34 of the brake device 4. The means for supplying hydraulic fluid comprises a hydraulic pump 36. Alternatively, the means could comprise, for instance, a cylinder and a piston driven in the cylinder. The piston could be driven, for instance, by means of a linear actuator. In the embodiment of FIG. 1, the means for supplying pressurized hydraulic fluid into the first and second fluid chamber 32, 34 also comprises a first valve 37 for controlling flow into and out of the first fluid chamber 32 and a second valve 38 for controlling flow into and out of the second fluid chamber 34. Each of the first valve 37 and the second valve 38 can connect the respective fluid chamber 32, 34 either to the pump 36 for supplying pressurized hydraulic fluid into the fluid chamber 32, 34 or to a tank 39 for discharging hydraulic fluid from the fluid chamber 32, 34. The valves 37, 38 also allow preventing fluid communication between the respective fluid chamber 32, 34 and the pump 36 and the tank 39. The flow into and out of the fluid chamber 32, 34 could also be controlled in many other alternative ways.

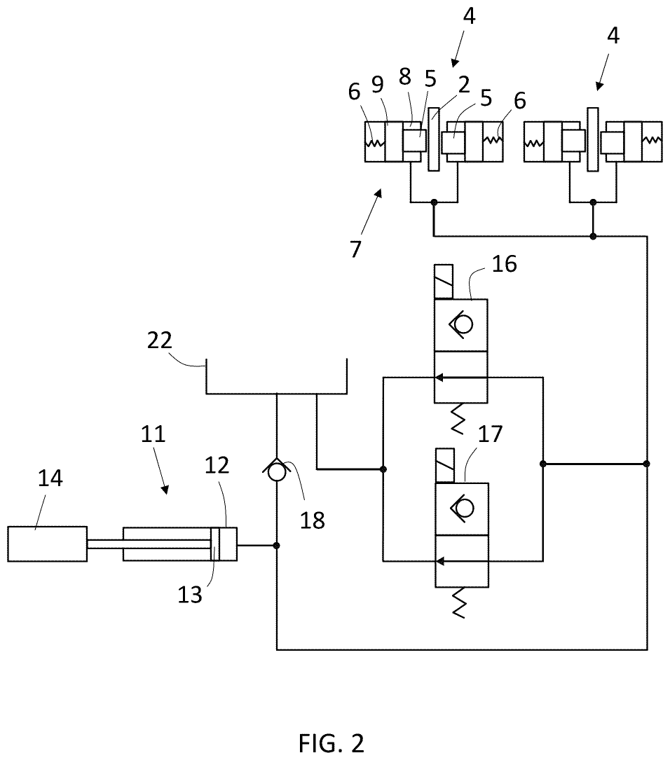

FIG. 2 shows schematically a hydraulic system that can be used for actuating the brake device 4. In the embodiment of FIG. 2, the brake system comprises two brake devices 4 connected to a common hydraulic circuit. However, the brake system could comprise only a single brake device 4 or more than two brake devices 4. In the embodiment of FIG. 2, each brake device 4 comprises two brake elements 5. The brake elements 5 are arranged on opposite sides of the guide rail 2. However, the brake device 4 could also be implemented with a single brake element 5.

The brake device 4 further comprises two biasing springs 6 that are configured to bias the brake elements 5 towards the braking position. The biasing springs 6 can be mechanical springs, such as coil springs. In the embodiment of FIG. 2, each brake element 5 is biased by means of one biasing spring 6 towards the braking position. The brake device 4 could comprise two or more biasing springs 6 for each brake element 5.

In the embodiment of FIG. 2, the brake release means 7 comprise two cylinders 8 and a moveable piston 9 arranged within each cylinder 8. The brake release means 7 are configured to move the respective brake element 5 to the release position when hydraulic pressure overcoming a biasing force caused by the biasing spring 6 is applied to the piston 9. The brake release means 7 can be integrated in the brake caliper. The number of the brake elements 5 and the cylinders 8 does not need to be the same.

The brake system comprises pressurizing means 11 comprising a hydraulic cylinder 12 and a piston 13 that is configured to be moveable relative to the hydraulic cylinder 12. The hydraulic cylinder 12 is thus stationary. Alternatively, the piston 13 could be stationary and the hydraulic cylinder 12 could be moveable. As the piston 13 and the hydraulic cylinder move relative to each other, the fluid volume of the hydraulic cylinder 12 changes.

The hydraulic cylinder 12 is arranged in fluid communication with the cylinders 8 of the brake release means 7 to allow supplying pressurized hydraulic fluid into the cylinders 8. The brake system further comprises a fluid reservoir 22 arranged in fluid communication with the cylinders 8 of the brake release means 7 and with the pressurizing means 11 for supplying hydraulic fluid to the pressurizing means 11 and for receiving hydraulic fluid from the cylinders 8 of the brake release means 7. The brake system also comprises two safety valves 16, 17. Each of the safety valves 16, 17 has a closed state and an open state, and each of the safety valves 16, 17 is arranged between the cylinders 8 of the brake release means 7 and the fluid reservoir 22. When at least one of the safety valves 16, 17 is in the open state, flow from the cylinders 8 into the fluid reservoir 22 is allowed. When both safety valves 16, 17 are in the closed state, flow from the cylinders 8 into the fluid reservoir 22 is prevented. Two safety valves 16, 17 provide redundancy, but the brake system could also be implemented with a single safety valve.

When at least one of the safety valves 16, 17 is open, the hydraulic fluid can flow from the cylinders 8 of the brake release means 7 into the fluid reservoir 22. If the pressurizing means 11 are operated, even hydraulic fluid from the hydraulic cylinder 12 of the pressurizing means 11 can flow into the fluid reservoir 22. There is thus no pressure in the hydraulic system of the brake system, and the biasing springs 6 can push the brake elements 5 to the braking positions, or keep the brake elements 5 in the braking positions.

When the safety valves 16, 17 are closed, hydraulic fluid cannot flow from the cylinders 8 of the brake release means 7 into the fluid reservoir 22. When the pressurizing means 11 are actuated, the hydraulic fluid in the hydraulic cylinder 12 of the pressurizing means 11 is pressurized. When the force exerted on the pistons 9 of the brake release means 7 exceeds the biasing force of the biasing springs 6, the hydraulic fluid flows into the cylinders 8 of the brake release means 7 and pushes the brake elements 5 to the release positions. The fluid line between the pressurizing means 11 and the fluid reservoir 22 is provided with a non-return valve 18, which allows flow from the fluid reservoir 22 to the pressurizing means 11, but prevents flow from the pressurizing means 11 into the fluid reservoir 22.

In the embodiment of FIG. 2, the safety valves 16, 17 are normally open valves. The safety valves 16, 17 are thus biased to an open position, for instance by means of a spring. Each of the valves 16, 17 is provided with an electrical actuator for switching the valve 16, 17 to the closed state. If the electrical actuator fails or there is a power failure, the valve 16, 17 is automatically switched to the open state. This releases pressure from the cylinders 8 of the brake release means 7 and switches the brake device 4 to a braking state. The brake arrangement thus functions in a safe manner in case of power failures and other fault situations.

The brake system can be provided with a linear actuator 14 for operating the pressurizing means 11. The linear actuator 14 can be an electrical linear motor. The linear actuator 14 can be coupled to either the piston 13 or the hydraulic cylinder 12 of the pressurizing means 11 for causing mutual linear movement of the piston 13 and the hydraulic cylinder 12. The linear actuator 14 can be provided with a brake. The brake can be, for instance, electrically actuated. When the brake is in a locked state, moving of the linear actuator 14 is prevented. Consequently, also the mutual movement of the piston 13 and the hydraulic cylinder 12 of the pressurizing means 11 is prevented. Pressure in the hydraulic system of the brake arrangement can thus be maintained even if the linear actuator 14 is not energized. This allows maintaining the brake device 4 in the release state with minimal energy consumption.

Instead of the hydraulically operable brake devices 4 of FIG. 2, the brake device 4 according to the invention could be electrically operated. For instance, the brake element 5 could be biased to the braking position by means of a spring, and moved to the retracted position by means of an electrical actuator.

The brake system according to the invention is configured to measure the pressure in the first fluid chamber 32 and/or in the second fluid chamber 34. Based on the measured pressure in the first fluid chamber 32 or in the second fluid chamber 34, the brake force applied to the guide rail 2 or to the brake disc 20 of the hoisting machinery 19 can be determined.

The determined brake force can be used for various purposes. For instance, based on the determined brake force, the weight of the elevator car 3 can be determined. By determining the brake force of two or more brake devices 4 of the elevator car 3, unbalance of the elevator car 3 can be determined. The determined brake force also allows fault diagnosis of the brake system. The determined brake force can also be used for closed loop control of the brake force.

By using the determined brake force as an input for controlling the braking of the elevator, undesired phenomena relating to stopping and starting can be avoided. For instance, controlled braking in case of an emergency stop allows smooth deceleration of the elevator car 3. Controlled release of the brakes helps avoiding bouncing in start.

According to an embodiment of the invention, the brake force is determined based on the pressure in the first fluid chamber 32 or the second fluid chamber 34. The determined brake force is compared to a reference value, and the brake force is adjusted based on the comparison.

According to another embodiment of the invention, brake force is applied to the guide rail 2 by means of the brake device 4 to keep the brake caliper 31 stationary relative to the guide rail 2. Pressurized hydraulic fluid is then supplied into the first fluid chamber 32 or the second fluid chamber 34 to move the elevator car 3 relative to the brake caliper 31. This allows releasing of an activated safety gear of the elevator car 3.

According to another embodiment of the invention, the elevator car 3 is moved along the guide rail 2, and brake force is applied to the guide rail 2 by means of the brake device 4. The pressure in the first fluid chamber 32 or second fluid chamber 34 is monitored, and the brake force is adjusted based on the pressure in the fluid chamber 32, 34 until a predetermined brake force is reached. The predetermined brake force is then maintained, and the elevator car 3 is kept moving along the guide rail 2 to clean the brake elements 5 of the brake device 4 and/or the guide rail 2. This allows a cleanup cycle with minimum brake force.

1. A brake device for an elevator car or a hoisting machinery of an elevator, the brake device being configured to cooperate with a guide rail of the elevator or with a brake disc of the hoisting machinery for applying a brake force to said guide rail or brake disc when actuated, the brake device comprising
a frame that is configured to be rigidly attached to the elevator car or to a stationary body part of the hoisting machinery,
a brake caliper slidably mounted to the frame,
at least one brake element that is mounted to the brake caliper and moveable between a braking position and a retracted position,
brake actuation means and brake release means for moving said at least one brake element between the braking position and the retracted position,
a fluid chamber and a piston having a first piston surface delimiting said fluid chamber, wherein one of the fluid chamber and the piston is configured to move with the brake caliper and the other is configured to move with the frame such that a brake force applied to the guide rail or to the brake disc by means of the brake device strives to move the piston and the fluid chamber relative to each other.

2. A brake device according to claim 1, wherein the brake device comprises means for monitoring the pressure in the fluid chamber.

3. A brake device according to claim 1, wherein the brake device comprises a second fluid chamber and a piston having a second piston surface delimiting the second fluid chamber, the first piston surface and the second piston surface facing opposite directions, wherein one of the second fluid chamber and the piston having the second piston surface is configured to move with the brake caliper and the other is configured to move with the frame such that a brake force applied to the guide rail or to the brake disc by means of the brake device strives to move the piston and the second fluid chamber relative to each other.

4. A brake device according to claim 3, wherein the brake device comprises means for monitoring the pressure in the second fluid chamber.

5. A brake device according to claim 3, wherein the brake device is configured to allow supply of pressurized hydraulic fluid into the fluid chambers and discharge of hydraulic fluid from the fluid chambers to move the frame relative to the brake caliper.

6. A brake device according to claim 1, wherein the brake actuation means comprise at least one biasing spring that is configured to bias said at least one brake element towards the braking position and the brake release means comprise at least one cylinder and a piston moveable within the cylinder, the brake release means being configured to move said at least one brake element to the release position when hydraulic pressure overcoming a biasing force caused by said at least one biasing spring is applied to the piston of the brake release means.

7. A brake system for an elevator, the brake system comprising at least one brake device according to claim 1 and means for monitoring the pressure in the fluid chamber.

8. A brake system according to claim 7, wherein the brake system comprises means for supplying pressurized hydraulic fluid into the fluid chamber.

9. A brake system according to claim 7, wherein the brake system is configured to control the brake force applied to the guide rail or to the brake disc based on the pressure in the fluid chamber.

10. A brake system according to claim 7, wherein the brake device is according to claim 6 and the brake system comprises pressurizing means configured to pressurize hydraulic fluid and being arranged in fluid communication with said at least one cylinder of the brake release means to allow supplying pressurized hydraulic fluid into said at least one cylinder.

11. A brake system according to claim 10, wherein the pressurizing means comprise a hydraulic cylinder and a piston that are configured to be moveable relative to each other to pressurize hydraulic fluid in the hydraulic cylinder, the hydraulic cylinder being arranged in fluid communication with said at least one cylinder of the brake release means to allow supplying pressurized hydraulic fluid into said at least one cylinder.

12. An elevator comprising an elevator car, a hoisting machinery and a brake system according to claim 7, wherein said at least one brake device is mounted to the elevator car or to the hoisting machinery.

13. A method of operating an elevator according to claim 12, wherein the method comprises the step of measuring the pressure in the fluid chamber.

14. A method according to claim 13, wherein the method comprises the step of determining, based on the measured pressure, the brake force applied by the brake device to the guide rail or to the brake disc .

15. A method according to claim 13, wherein the method comprises the step of determining, based on the measured pressure, the weight of the elevator car.

16. A method according to claim 13, wherein the method comprises the step of controlling, based on the measured pressure, the brake force applied to the guide rail or to the brake disc by the brake device.

17. A method according to claim 13, wherein the method comprises the steps of applying a brake force to the guide rail or to the brake disc by means of the brake device, determining the brake force based on the pressure in the fluid chamber, comparing the determined brake force to a reference value, and adjusting the brake force based on the comparison.

18. A method according to claim 13, wherein the brake device is mounted to the elevator car and the method comprises the steps of applying a brake force to the guide rail by means of the brake device to keep the brake caliper stationary relative to the guide rail, and supplying pressurized hydraulic fluid into the fluid chamber to move the elevator car relative to the brake caliper.

19. A method according to claim 13, wherein the brake device is mounted to the elevator car and the method comprises the steps of moving the elevator car along the guide rail, applying a brake force to the guide rail by means of the brake device, monitoring the pressure in the fluid chamber, adjusting the brake force based on the pressure in the fluid chamber until a predetermined brake force is reached, maintaining said predetermined brake force, and keeping the elevator car moving along the guide rail to clean said at least one brake element of the brake device and/or the guide rail.

20. A brake device according to claim 2, wherein the brake device comprises a second fluid chamber and a piston having a second piston surface delimiting the second fluid chamber, the first piston surface and the second piston surface facing opposite directions, wherein one of the second fluid chamber and the piston having the second piston surface is configured to move with the brake caliper and the other is configured to move with the frame such that a brake force applied to the guide rail or to the brake disc by means of the brake device strives to move the piston and the second fluid chamber relative to each other.
